(19) United States
(12) Patent Application Publication
(10) Pub. No.: US 2006/0082683 A1
(43) Pub. Date: Apr. 20, 2006

(54) TACTILE SWITCH MECHANISM

(76) Inventors: Ho-Shih Wu, Taipei City (TW); Jih-Yung Lu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,312

(22) Filed: Oct. 13, 2005

(30) Foreign Application Priority Data
Oct. 15, 2004 (TW) 093216470

(51) Int. Cl. H04N 5/225

(52) U.S. Cl. 348/375

(57) ABSTRACT

A tactile switch mechanism includes a circuit board including a plurality of sunken sections and a plurality of sensing sections. Each sunken section is located in a position corresponding to one of the sensing sections. The tactile switch mechanism further includes a dial module. The dial module includes a switching component, and a first end of the switching component is used for contacting one of the plurality of sensing sections and a second end of the switching component is used for sliding into one of the plurality of sunken sections. The dial module further includes an input component connected to the switching component for driving the first end of the switching component to switch between the plurality of sensing sections and for driving the second end of the switching component to switch between the plurality of sunken sections.

### BACKGROUND OF INVENTION

1. Field of the Invention

The present invention relates to a tactile switch mechanism, and more particularly, to a tactile switch mechanism containing sunken sections formed on a circuit board and including corresponding sensing sections to provide users a tactile switching feeling.

2. Description of the Prior Art

In the modern information-oriented society, it is desirable that users can input control instructions with a user-friendly man-machine interface. For example, there are various kinds of switches. The common function mode switch used in a digital camera usually includes a rotating brush and a tactile switch mechanism, and the user can feel the switching action when the rotating brush slides on the tactile switch mechanism to switch between different functions.

However, the conventional tactile switch mechanism needs an extra component to match up with the brush in order to achieve the tactile effect. Hence, the extra component brings extra manufacturing cost and difficulty in positioning the extra component inside the narrow space of the tactile switch mechanism.

### SUMMARY OF INVENTION

It is therefore a primary objective of the claimed invention to provide a tactile switch mechanism containing sunken sections formed on a circuit board and including corresponding sensing sections to provide users a tactile switching feeling for solving the above-mentioned problem.

According to claimed invention, a tactile switch mechanism includes a circuit board including a plurality of sunken sections and a plurality of sensing sections. Each sunken section is located in a position corresponding to one of the sensing sections. The tactile switch mechanism further includes a dial module. The dial module includes a switching component, and a first end of the switching component is used for contacting one of the plurality of sensing sections and a second end of the switching component is used for sliding into one of the plurality of sunken sections. The dial module further includes an input component connected to the switching component for driving the first end of the switching component to switch between the plurality of sensing sections and for driving the second end of the switching component to switch between the plurality of sunken sections.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic drawing of a digital camera of a first embodiment according to the present invention.

FIG. 2 is an exploded drawing of a tactile switch mechanism of the first embodiment according to the present invention.

FIG. 3 is a schematic drawing illustrating the tactile switch mechanism in FIG. 2 completely fabricated.

FIG. 4 illustrates another embodiment of sunken sections on a circuit board.

FIG. 5 is a schematic drawing of a digital camera of a second embodiment according to the present invention.

FIG. 6 is an exploded drawing of a tactile switch mechanism of the second embodiment according to the present invention.

FIG. 7 is a schematic drawing illustrating the tactile switch mechanism in FIG. 6 completely fabricated.

### DETAILED DESCRIPTION

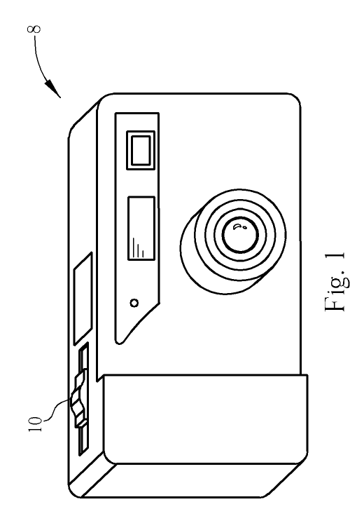

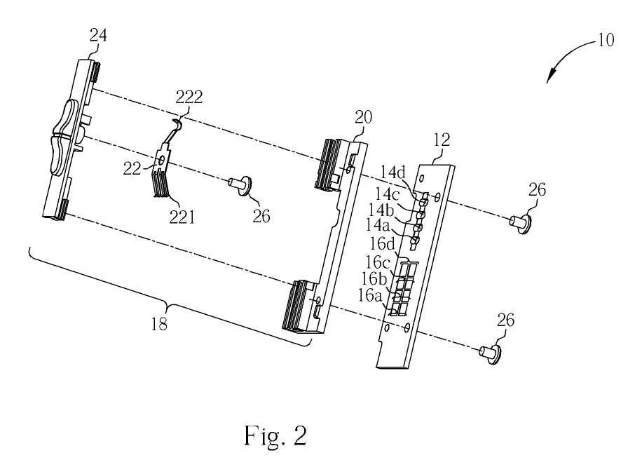

Please refer to FIG. 1. FIG. 1 is a schematic drawing of a digital camera 8 of a first embodiment according to the present invention. The digital camera 8 includes a tactile switch mechanism 10 installed on the housing of the digital camera 8 for switching function modes of the digital camera 8. Please refer to FIG. 2. FIG. 2 is an exploded drawing of the tactile switch mechanism 10 of the first embodiment according to the present invention. The tactile switch mechanism 10 can be a function mode switch of the digital camera 8. The tactile switch mechanism 10 includes a circuit board 12 including four sunken sections 14a, 14b, 14c, and 14d. The four sunken sections 14a, 14b, 14c, 14d are positioned in a line on the circuit board 12. The four sunken sections 14a, 14b, 14c, 14d can be holes or notches sunken below the surface of the circuit board 12. The circuit board 12 further includes four sensing sections 16a, 16b, 16c, and 16d. The four sensing sections 16a, 16b, 16c, 16d are positioned in two lines on the circuit board 12, and each sunken section is located in a position corresponding to one of the sensing sections. That is, the sunken section 14a corresponds to the sensing section 16a, the sunken section 14b corresponds to the sensing section 16b, the sunken section 14c corresponds to the sensing section 16c, and the sunken section 14d corresponds to the sensing section 16d. Metal material, such as Au or Cr, can be applied to sliding surfaces of the sunken sections 14a, 14b, 14c, 14d for enhancing the wear resistance and the reliability of the sunken sections 14a, 14b, 14c, 14d. The sensing sections 16a, 16b, 16c, 16d are made of metal material for conducting electricity.

The tactile switch mechanism 10 further includes a dial module 18 including a base 20, a switching component 22, and an input component 24. The base 20 is used for supporting the switching component 22 and the input component 24. A first end 221 of the switching component 22 is a brush for contacting one of the sensing sections 16a, 16b, 16c, 16d, and a second end 222 of the switching component 22 is a fragment for sliding into one of the sunken sections 14a, 14b, 14c, 14d. The switching component 22 can be made of metal material with high structural strength and good electric conductivity, such as phosphor, bronze, and so on, so that the switching component 22 can conduct electricity from the sensing section effectively and can not be worn away easily due to repeating sliding motion. The input component 24 is connected to the switching component 22 for driving the first end 221 of the switching component 22 to switch between the sensing sections 16a, 16b, 16c, 16d and for driving the second end 222 of the switching component 22 to switch between the sunken sections 14a, 14b, 14c, 14d. The input component 24 is a sliding-graduated key so that a user can decide the operating function mode by sliding the input component 24.

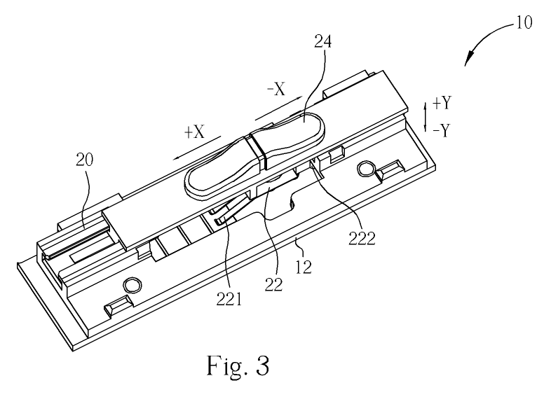

As for the fabrication of the tactile switch mechanism 10, the input component 24 can be wedged into the base 20 first, and then the switching component 22 can be combined with the input component 24 with a screw 26. At last the dial module 18 can be combined with the circuit board 12 with two screws 26. The combination of the switching component 22 and the input component 24 and the combination of the dial module 18 and the circuit board 12 are not limited to the use of the screw mechanism. Please refer to FIG. 3. FIG. 3 is a schematic drawing illustrating the tactile switch mechanism 10 completely fabricated. The user can slide the input component 24 in the +X or −X directions to switch the corresponding operating function modes. As shown in FIG. 2 and FIG. 3, when the input component 24 is pushed to the end in the +X direction, the first end 221 of the switching component 22 contacts the sensing section 16a on the circuit board 12 and the two sensing areas at the left and right sides of the sensing section 16a can be electrically connected via the contact with the two sensing areas respectively. In addition, the second end 222 of the switching component 22 is wedged into the sunken section 14a on the circuit board 12, and at the same time the digital camera 8 is in a first operating function mode. When the input component 24 is pushed in a small distance in the −X direction, the first end 221 of the switching component 22 contacts the sensing section 16b on the circuit board 12 and the two sensing areas at the left and right sides of the sensing section 16b can be electrically connected via the contact with the two sensing areas respectively. At this time the second end 222 of the switching component 22 is wedged into the sunken section 14b from the sunken section 14a on the circuit board 12. Because there is a height difference between the sunken section 14a and the surface of the circuit board 12 and between the sunken section 14b and the surface of the circuit board 12, the user can experience the tactile switching action when switching from the first operating function mode to a second operating function mode of the digital camera 8 due to the motion of the second end 222 of the switching component 22 in the +Y and −Y directions vertical to the circuit board 12 when the switching component 22 is switched from the sunken section 14a to the sunken section 14b. Similarly, the action mechanism of the sensing sections 16c, 16d and the respectively corresponding sunken sections 14c, 14d are the same as what is mentioned above. Because there are four groups of the sensing sections 16a, 16b, 16c, 16d and the corresponding sunken sections 14a, 14b, 14c, 14d of the tactile switch mechanism 10, the tactile switch mechanism 10 can provide the digital camera 8 with four different operating function modes. The tactile switch mechanism 10 can include any number of groups of the sensing sections and the corresponding sunken sections, and the chosen number will depend on the number of operating function modes that the camera has.

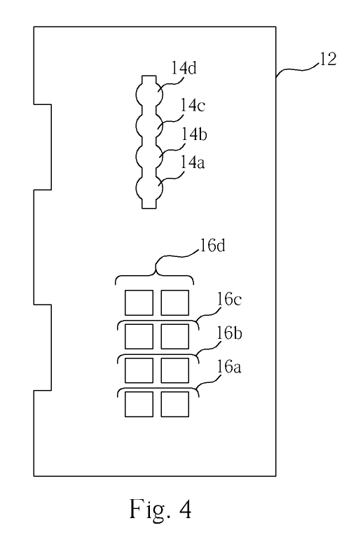

The sunken sections 14a, 14b, 14c, 14d can be designed as four separating notches or holes as shown in FIG. 2 or can be designed as a joined notch or a hole. Please refer to FIG. 4. FIG. 4 illustrates another embodiment of the sunken sections on the circuit board 12. The sunken sections 14a, 14b, 14c, 14d shown in FIG. 4 are joined, and only the sunken sections 14a, 14b, 14c, 14d can contain the second end 222 of the switching component 22. The action mechanism in this embodiment is the same as what was mentioned above.

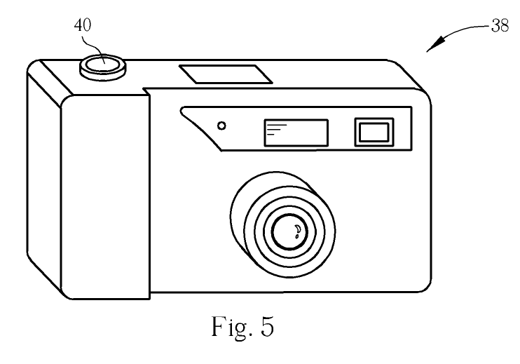

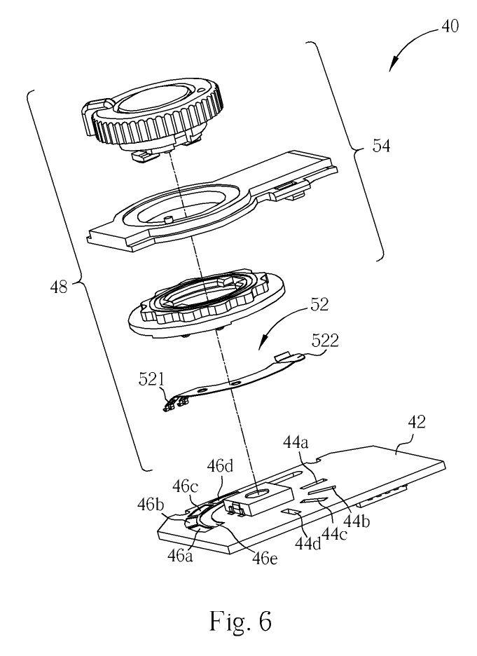

Based on the action mechanism of the present invention, the tactile switch mechanism of the present invention can be applied to different switching motions. Please refer to FIG. 5. FIG. 5 is a schematic drawing of a digital camera 38 of a second embodiment according to the present invention. The digital camera 38 includes a tactile switch mechanism 40 installed on the housing of the digital camera 38 for switching function modes of the digital camera 38. The tactile switch mechanism 40 is different from the tactile switch mechanism 10 in that the tactile switch mechanism 40 is a rotating-graduated key. Please refer to FIG. 6. FIG. 6 is an exploded drawing of the tactile switch mechanism 40 of the second embodiment according to the present invention. The tactile switch mechanism 40 includes a circuit board 42 including four sunken sections 44a, 44b, 44c, and 44d. The four sunken sections 44a, 44b, 44c, 44d are positioned in an arc on the circuit board 42. The four sunken sections 44a, 44b, 44c, 44d can be holes or notches sunken below the surface of the circuit board 42. The circuit board 42 further includes five sensing sections 46a, 46b, 46c, 46c, and 46e. The five sensing sections 46a, 46b, 46c, 46c, 46e are positioned in two concentric arcs on the circuit board 42, and each sunken section is located in a position corresponding to one of the sensing sections. That is, the sunken section 44a corresponds to the sensing sections 46a, 46e, the sunken section 44b corresponds to the sensing sections 46b, 46e, the sunken section 44c corresponds to the sensing sections 46c, 46e, and the sunken section 44d corresponds to the sensing section 46d, 46e. The metal material, such as Au, Cr, can be applied to sliding surfaces of the sunken sections 44a, 44b, 44c, 44d for enhancing the wear resistance and the reliability of the sunken sections 44a, 44b, 44c, 44d. The sensing sections 46a, 46b, 46c, 46d, 46e are made of metal material for conducting electricity.

The tactile switch mechanism 40 further includes a dial module 48 including a switching component 52, and an input component 54. A first end 521 of the switching component 52 is a brush for contacting one of the sensing sections 46a, 46b, 46c, 46d, and a second end 522 of the switching component 52 is a fragment for sliding into one of the sunken sections 44a, 44b, 44c, 44d. The switching component 52 can be made of metal material with high structural strength and good electric conductivity, such as phosphor, bronze, and so on, so that the switching component 52 can conduct electricity from the sensing section effectively and can not be worn away easily due to repeating rotating motion. The input component 54 is connected to the switching component 52 for driving the first end 521 of the switching component 52 to switch between the sensing sections 46a, 46b, 46c, 46d and for driving the second end 522 of the switching component 52 to switch between the sunken sections 44a, 44b, 44c, 44d. The input component 54 is a sliding-graduated key so that a user can decide the operating function mode by rotating the input component 54.

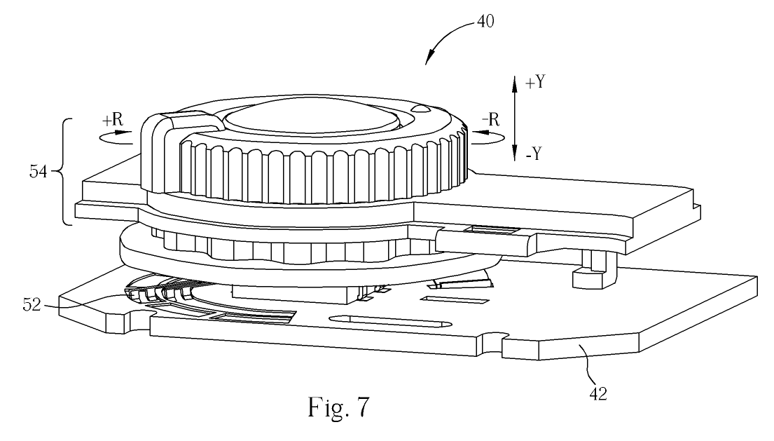

As for the fabrication of the tactile switch mechanism 40, the switching component 52 can be combined with the input component 54, and then the dial module 48 can be combined with the circuit board 42. The combination of the switching component 52 and the input component 54 and the combination of the dial module 48 and the circuit board 42 are similar with what was described above in the first embodiment. Please refer to FIG. 7. FIG. 7 is a schematic drawing illustrating the tactile switch mechanism 40 completely fabricated. The user can rotate the input component 54 in a clockwise direction (+R) or in a counterclockwise direction (−R) to switch the corresponding operating function modes. As shown in FIG. 6 and FIG. 7, when the input component 54 is rotated to the end in the −R direction, the first end 521 of the switching component 52 contacts the sensing section 46a and the sensing section 46e on the circuit board 12 and the sensing section 46a and the sensing section 46e can be electrically connected. In addition, the second end 522 of the switching component 52 is wedged into the sunken section 54a on the circuit board 42, and at the same time the digital camera 38 is in a first operating function mode. When the input component 54 is rotated a small distance in the +R direction, the first end 521 of the switching component 52 contacts the sensing section 46b and the sensing section 46e on the circuit board 42 and the sensing section 46b and the sensing section 46e can be electrically connected. At this time the second end 522 of the switching component 52 is wedged into the sunken section 44b from the sunken section 44a on the circuit board 42. Because there is a height difference between the sunken section 44a and the surface of the circuit board 42 and between the sunken section 44b and the surface of the circuit board 42, the user can experience the tactile switching action when switching from the first operating function mode to a second operating function mode of the digital camera 38 due to the motion of the second end 522 of the switching component 52 in the +Y and −Y directions vertical to the circuit board 42 when the switching component 52 is switched from the sunken section 44a to the sunken section 44b. Similarly, the action mechanism of the sensing sections 46c, 46d, 46e and the corresponding sunken sections 44c, 44d is the same as what was mentioned above. Because there are four groups of the sensing sections and the corresponding sunken sections of the tactile switch mechanism 40, the tactile switch mechanism 40 can provide the digital camera 38 with four different operating function modes. The tactile switch mechanism 40 can include any number of groups of the sensing sections and the corresponding sunken sections, depending on the number of operating function modes to be used.

In contrast to the prior art, the tactile switch mechanism of the present invention utilizes sunken sections on the circuit board including the corresponding sensing sections to provide users with a tactile switching feeling. There is no need to apply an extra component to contact with the brush for achieving the tactile switching effect. Hence the present invention can economize the manufacturing cost, reduce the amount of mechanical space required, and can be fabricated conveniently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tactile switch mechanism comprising:
a circuit board comprising a plurality of sunken sections and a plurality of sensing sections, each sunken section being located in a position corresponding to one of the sensing sections; and
a dial module comprising:
a switching component, a first end of the switching component being used for contacting one of the plurality of sensing sections and a second end of the switching component being used for sliding into one of the plurality of sunken sections; and
an input component connected to the switching component for driving the first end of the switching component to switch between the plurality of sensing sections and for driving the second end of the switching component to switch between the plurality of sunken sections.

2. The tactile switch mechanism of claim 1 wherein the first end of the switching component is a brush and the second end of the switching component is a fragment.

3. The tactile switch mechanism of claim 1 wherein each of the sunken sections is a hole.

4. The tactile switch mechanism of claim 1 wherein the circuit board further comprises a first sunken section, a second sunken section, a first sensing section, and a second sensing section, the first end of the switching component is a brush for contacting the first sensing section and the second sensing section, and the second end of the switching component is a fragment for sliding into the first sunken section when the brush contacts the first sensing section and for sliding into the second sunken section when the brush contacts the second sensing section.

5. The tactile switch mechanism of claim 4 wherein the first sunken section and the second sunken section are holes.

6. The tactile switch mechanism of claim 1 wherein the plurality of sensing sections is made of metal material.

7. The tactile switch mechanism of claim 1 wherein the switching component is made of metal material.

8. The tactile switch mechanism of claim 1 wherein the switching component is locked to the input component with a screw.

9. The tactile switch mechanism of claim 1 wherein the input component is a sliding-graduated key.

10. The tactile switch mechanism of claim 1 wherein the input component is a rotating-graduated key.

11. The tactile switch mechanism of claim 1 wherein the plurality of sensing sections is positioned in two parallel lines on the circuit board.

12. The tactile switch mechanism of claim 111 wherein the plurality of sunken sections is positioned in one line on the circuit board.

13. The tactile switch mechanism of claim 12 wherein each of the sunken sections is a hole.

14. The tactile switch mechanism of claim 11 wherein the input component is a sliding-graduated key.

15. The tactile switch mechanism of claim 1 wherein the plurality of sensing sections is positioned in two concentric arcs on the circuit board.

16. The tactile switch mechanism of claim 15 wherein the plurality of sunken sections is positioned in an arc on the circuit board.

17. The tactile switch mechanism of claim 16 wherein each of the sunken sections is a hole.

18. The tactile switch mechanism of claim 15 wherein the input component is a rotating-graduated key.

19. The tactile switch mechanism of claim 1 being a function mode switch.
